(19) United States
(12) Patent Application Publication
(10) Pub. No.: US 2022/0112575 A1
(43) Pub. Date: Apr. 14, 2022

(54) A HIGH STRENGTH HIGH DUCTILITY COMPLEX PHASE COLD ROLLED STEEL STRIP OR SHEET

(71) Applicant: VOESTALPINE STAHL GMBH, Linz (AT)

(72) Inventors: Johannes REHRL, St. Marien (AT); Martin GRUBER, Pregarten (AT); Florian WINKELHOFER, Kirchberg-Thening (AT); Thomas HEBESBERGER, Pasching (AT)

(21) Appl. No.: 17/423,762

(22) PCT Filed: Nov. 28, 2019
(86) PCT No.: PCT/EP2019/082857

§ 371 Date: Jul. 16, 2021

(30) Foreign Application Priority Data
Jan. 22, 2019 (EP) 19153131.8
Jan. 22, 2019 (SE) 1950073-5

(51) Int. Cl. C21D 9/52; B32B 15/01; C22C 38/58; C22C 38/54; C22C 38/50; C22C 38/42; C22C 38/06; C22C 38/02; C22C 38/00; C21D 8/04; C21D 6/00

(52) U.S. Cl. CPC C21D 9/52; C21D 2211/001; C22C 38/58; C22C 38/54; C22C 38/50; C22C 38/42; C22C 38/06; C22C 38/02; C22C 38/002; C22C 38/001; C21D 8/0426; C21D 8/0436; C21D 8/0405; C21D 6/008; C21D 6/005; C21D 6/004; C21D 2211/008; C21D 2211/005; B32B 15/013

(57) ABSTRACT

A cold rolled steel strip or sheet has a composition consisting of (in wt. %): C 0.15-0.25; Si 0.5-1.6; Mn 2.2-3.2; Cr≤0.8; Mo≤0.2; Al 0.03-1.0; Nb≤0.04; V≤0.04; Ti 0.01-0.04; B 0.001-0.010; TUB 5-30; Cu≤0.15; Ni≤0.15; Ca≤0.01; balance Fe apart from impurities, where the cold rolled steel has a multiphase microstructure comprising a matrix mainly composed of tempered martensite and has a tensile strength (Rₘ) of at least 1380 MPa.

### CROSS-REFERENCE TO RELATED APPLICATION(S)

This is a National Stage Entry into the United States Patent and Trademark Office from International Patent Application No. PCT/EP2019/082857, filed on Nov. 28, 2019, which claims priority to Swedish Patent Application No. SE 1950073-5, filed on Jan. 22, 2019, and to European Patent Application No. EP 19153131.8, filed on Jan. 22, 2019, the entire contents of all of which are incorporated herein by reference.

### FIELD OF THE INVENTION

The present invention relates to high strength steel strips and sheets suitable for applications in automobiles. In particular, the invention relates to high ductility high strength complex phase cold rolled steel having a tensile strength of at least 1380 MPa and an excellent formability.

### BACKGROUND OF THE INVENTION

For a great variety of applications increased strength levels are a pre-requisite for light-weight constructions in particular in the automotive industry, since car body mass reduction results in reduced fuel consumption.

Automotive body parts are often stamped out of sheet steels, forming complex structural members of thin sheet. However, such parts cannot be produced from conventional high strength steels, because of a too low formability of the complex structural parts. For this reason, multi-phase Transformation Induced Plasticity aided steels (TRIP steels) have gained considerable interest in the last years, in particular for use in auto body structural parts and as seat frame materials.

TRIP steels possess a multi-phase microstructure, which includes a meta-stable retained austenite phase, which is capable of producing the TRIP effect. When the steel is deformed, the austenite transforms into martensite, which results in remarkable work hardening. This hardening effect acts to resist necking in the material and postpones failure in sheet forming operations. The microstructure of a TRIP steel can greatly alter its mechanical properties. The most important aspects of the TRIP steel microstructure are the volume percentage, size and morphology of the retained austenite phase, as these properties directly affect the austenite to martensite transformation, when the steel is deformed. There are several ways by which it is possible to chemically stabilize austenite at room temperature. In low alloy TRIP steels the austenite is stabilized through its carbon content and the small size of the austenite grains. The carbon content necessary to stabilize austenite is approximately 1 wt. %. However, high carbon content in steel cannot be used in many applications because of impaired weldability.

Specific processing routs are therefore required to concentrate the carbon into the austenite in order to stabilize it at room temperature. A common TRIP steel chemistry also contains small additions of other elements to help stabilizing the austenite as well as aiding the creation of microstructures which partition carbon into the austenite. In order to inhibit the austenite to decompose during the bainite transformation it has generally been considered necessary to add relatively high amounts of manganese and silicon.

TRIP-aided steel with a Bainitic Ferrite matrix (TBF)-steels have been known for long and attracted a lot of interest, mainly because the bainitic ferrite matrix allows an excellent stretch flangability. Moreover, the TRIP effect ensured by the strain-induced transformation of metastable retained austenite islands into martensite, remarkably improves their drawability.

Complex Phase (CP) steels are characterized by very high strength levels and at the same time a high yield point and are therefore often used for crash-relevant components in cars.

Although these steels disclose several attractive properties there is a demand for steel sheets having a higher tensile strength in combination with a good workability, in particular, in applications where the local elongation and is great of importance for avoiding edge tearing, such as for advanced forming operations as bending and roll forming.

### SUMMARY OF THE INVENTION

The present invention is directed to cold rolled steels having a tensile strength of at least 1380 MPa and an excellent formability, wherein it should be possible to produce the steel sheets on an industrial scale in a Continuous Annealing Line (CAL). The invention aims at providing a steel having a composition and microstructure that can be processed to complicated high strength structural members, where the local elongation is of importance. In particular, the steel strip or sheet of the present invention should have a high hole expandability as expressed by the Hole Expanding Ratio (HER) or (λ). In this application lambda (λ) will be used for this parameter. Naturally, the steel should also have a good weldability, in particular with respect to Resistance Spot Welding (RSW) since RSW is the dominating welding process used in the mass fabrication of automobiles.

### DETAILED DESCRIPTION OF EMBODIMENT(S) OF THE INVENTION

The steel sheet has a composition consisting of the following alloying elements (in

| | |
|---|---|
| C | 0.15-0.25 |
| Si | 0.5-1.6 |
| Mn | 2.2-3.2 |
| Cr | ≤0.8 |
| Mo | ≤0.2 |
| Al | 0.03-1.0 |
| Nb | ≤0.04 |
| V | ≤0.04 |
| Ti | 0.01-0.04 |
| B | 0.001-0.010 |
| Ti/B | 5-30 |
| Cu | ≤0.15 |
| Ni | ≤0.15 |

balance Fe apart from impurities, the balance consists of iron and impurities.

The importance of the separate elements and their interaction with each other as well as the limitations of the chemical ingredients of the claimed alloy are briefly explained in the following. All percentages for the chemical composition of the steel are given in weight % (wt. %) throughout the description. Upper and lower limits of the individual elements can be freely combined within the limits set out in the claims. The arithmetic precision of the numerical values can be increased by one or two digits for all values given in the present application. Hence, a value reported as e.g. 0.1% can also be expressed as 0.10 or 0.100%. The amounts of the microstructural constituents are given in volume % (vol. %).

### C: 0.15-0.25%

C stabilizes the austenite and is important for obtaining sufficient carbon within the retained austenite phase. C is also important for obtaining the desired strength level. Generally, an increase of the tensile strength in the order of 100 MPa per 0.1% C can be expected. When C is lower than 0.15% then it is difficult to attain a tensile strength of 1380 MPa. If C exceeds 0.25%, then the weldability is impaired. The upper limit may thus be 0.24, 0.23 or 0.22%. The lower limit may be 0.16, 0.17, 0.18, 0.19, or 0.20%.

### Si: 0.5-1.6%

Si acts as a solid solution strengthening element and is important for securing the strength of the thin steel sheet. Si suppresses the cementite precipitation and is essential for austenite stabilization.

However, if the content is too high, then too much silicon oxides will form on the strip surface, which may lead to cladding on the rolls in the CAL and, as a result thereof, to surface defects on subsequently produced steel sheets. The upper limit is therefore 1.6% and may be restricted to 1.5, 1.4, 1.3, 1.2, 1.1 or 1.0%. The lower limit is 0.5% may be ste to 0.55, 0.60, 0.65, 0.70, 0.75 or 0.80%.

### Mn: 2.2-3.2%

Manganese is a solid solution strengthening element, which stabilises the austenite by lowering the Mₛ temperature and it also prevents ferrite and pearlite to be formed during cooling. In addition, Mn lowers the A_{c3} temperature and is important for the austenite stability. At a content of less than 2.2% it might be difficult to obtain the desired amount of retained austenite, a tensile strength of 980 MPa and the austenitizing temperature might be too high for conventional industrial annealing lines. In addition, at lower contents it may be difficult to avoid the formation of polygonal ferrite. However, if the amount of Mn is higher than 2.8%, problems with segregation may occur because Mn accumulates in the liquid phase and causes banding, resulting in a potentially deteriorated workability. The upper limit may therefore be 3.1, 3.0, 2.9, 2.8, 2.7, 2.6, 2.5 or 2.4%. The lower limit may be 2.25, 2.30, 2.35 or 2.40%.

### Cr: ≤0.8%

Cr is effective in increasing the strength of the steel sheet. However, a deliberate addition of Cr is not necessary according to the present invention. Cr is an element that forms ferrite and retards the formation of pearlite and bainite. The A_{c3} temperature and the Mₛ temperature are only slightly lowered with increasing Cr content. Cr results in an increased amount of stabilized retained austenite. The amount of Cr is limited to 0.8%. The upper limit may be 0.75, 0.70, 0.65, 0.60, 0.55, 0.50, 0.45 or 0.40, 0.35, 0.30 or 0.25%. The lower limit may be 0.01, 0.03, 0.05, 0.07, 0.10, 0.12, 0.15, 0.17, 0.20 or 0.25%. The lower limit of Cr is 0.10% in a preferred embodiment of the present invention.

### Mo: ≤0.2

Mo may optionally be contained in an amount of up to 0.2% for increasing the hardenability. Mo delays the decomposition of austenite and stabilizes the retained austenite. Amounts of more than 0.2% results in high costs. The lowest amount may be set to 0.001, 0.005, 0.01, 0.02, 0.03, 0.04 or 0.05%.

### Al: 0.03-1.0%

Al promotes ferrite formation and is also commonly used as a deoxidizer. Al, like Si, is not soluble in the cementite and therefore it delays the cementite formation during bainite formation considerably. Additions of Al result in a remarkable increase in the carbon content in the retained austenite. However, the Mₛ temperature is also increased with increasing Al content. A further drawback of Al is that it results in a drastic increase in the A_{c3} temperature. However, a main disadvantage of Al is its segregation behavior during casting. During casting Mn is enriched in the middle of the slabs and the Al-content is decreased. Therefore, in the middle of the slab a significant austenite stabilized region or band may be formed. This results, at the end of the processing, in martensite banding and in the that low strain internal cracks are formed in the martensite bands. On the other hand, Si and Cr are also enriched during casting. Hence, the propensity for martensite banding may be reduced by alloying with Si and Cr, since the austenite stabilization due to the Mn enrichment is counteracted by these elements. For these reasons the Al content is preferably limited. The upper level may be 0.9, 0.8, 0.7, 0.6, 0.5, 0.4, 0.3, 0.2 or 0.1%. The lower limit may be set to 0.04, 0.05, 0.06, 0.07, 0.08, 0.09 or 0.1%. If Al is used for deoxidation only, then the upper level may then be 0.09, 0.08, 0.07 or 0.06%. For securing a certain effect the lower level may set to 0.03 or 0.04%.

### Nb: ≤0.04%

Nb is commonly used in low alloyed steels for improving strength and toughness, because of its influence on the grain size. Nb increases the strength elongation balance by refining the matrix microstructure and the retained austenite phase due to the precipitation of NbC. The steel may contain Nb in an amount of ≤0.04%, preferably ≤0.03%. A deliberate addition of Nb is not necessary according to the present invention. The upper limit may therefore be restricted to ≤0.01%.

### V: ≤0.04%

The function of V is similar to that of Nb in that it contributes to precipitation hardening and grain refinement. The steel may contain V in an amount of ≤0.04%, preferably ≤0.03%. A deliberate addition of V is not necessary according to the present invention. The upper limit may therefore be restricted to ≤0.01%.

### Ti: 0.01-0.04%

Ti is commonly used in low alloyed steels for improving strength and toughness, because of its influence on the grain size by forming carbides, nitrides or carbonitrides. In particular, Ti is a strong nitride former and can be used to bind the nitrogen in the steel. However, the effect tends to be saturated above 0.04%. In order to having a good fixation of N to Ti the lower amount should be 0.01% and may be set to 0.02%.

### B: 0.001-0.010%

B suppresses the formation of ferrite and improves the weldability of the steel sheet. In order to have a noticeable effect at least 0.001% should be added. However, excessive amounts of B deteriorate the workability. The upper limit is therefore 0.010%. The upper limit may be set to 0.009, 0.008, 0.007, 0.006 or 0.005%. A preferred range is 0.002-0.004%.

### Ca≤0.01

Ca may be used for the modification of the non-metallic inclusions. The upper limit is 0.01% and may be set to 0.005 or 0.004%.

### Cu: ≤0.15%

Cu is an undesired impurity element that is restricted to ≤0.15% by careful selection of the scrap used. The upper limit may be restricted to 0.12, 0.10, 0.08 or 0.06%.

### Ni: ≤0.15%

Ni is also an undesired impurity element that is restricted to ≤0.15% by careful selection of the scrap used. The upper limit may be restricted to 0.12, 0.10, 0.08 or 0.06%.

Other impurity elements may be comprised in the steel in normal occurring amounts. However, it is preferred to limit the amounts of P, S to the following optional maximum contents:
P: ≤0.05, ≤0.04, ≤0.03 or ≤0.02%
S: ≤0.05, ≤0.03, ≤0.01, ≤0.005 or ≤0.001%
N: ≤0.03, ≤0.01, ≤0.007, ≤0.006 or ≤0.03, ≤0.006 or ≤0.005.

It is preferred to control the nitrogen content to the range of 0.002-0.006%, preferably to 0.003-0.005% if a stable fixation of nitrogen is desired.

### Ti/B: 5-30

The ratio TUB is preferably adjusted to be in the range of 5-30 in order to secure an optimal fixation of the nitrogen in the steel, resulting in free unbounded boron in the steel. Preferably, such ratio can be adjusted to be in the range of 8-11.

The cold rolled steel sheets of the present invention have a microstructure mainly consisting of retained austenite embedded in a matrix of tempered martensite (TM), i.e. the amount of tempered martensite is at least ≥40%, generally ≥50%. The lower limit of TM may be set to 55, 60, 65, 70 or 75%.

The microstructure may also contain up to 40% bainitic ferrite (BF) and up to 20% fresh martensite (FM). The latter may be present in the final microstructure because, depending on its stability, some austenite may transform to martensite during cooling at the end of the overaging step. The amount of FM may be limited to 15, 12, 10, 8 or 5%.

Retained austenite (RA) is a prerequisite for obtaining the desired TRIP effect. The amount of retained austenite should therefore be in the range of 2-20%. The lower limit of retained austenite may be set to 3, 4, 5, 6, 7 or 8%. A preferred range is 5-15%. The amount of retained austenite was measured by means of the saturation magnetization method described in detail in Proc. Int. Conf. on TRIP-aided high strength ferrous alloys (2002), Ghent, Belgium, p. 61-64.

Polygonal ferrite (PF) is not a desired microstructural constituent and is therefore limited to ≤10%, preferably ≤9%, ≤8%, ≤7%, ≤6%, ≤5%, ≤4%, ≤3% or ≤1%. Most preferably, the steel is free from PF.

The mechanical properties of the claimed steel are important and at least one of the following requirements should be fulfilled:

| | | |
|---|---|---|
| tensile strength (Rₘ) | ≥1380 | MPa |
| yield strength (R_{p0.2}) | ≥1000 | MPa |
| total elongation (A₈₀) | ≥5 | % |
| hole expansion ratio (λ) | ≥40 | % |
| yield ratio (R_{p0.2}/Rₘ) | ≥0.60. | |

Preferably, all these requirements are fulfilled at the same time.

The lower limit for the tensile strength (Rₘ) may be set to 1390, 1400, 1410, 1420 or 1430 MPa.

The lower limit for the yield strength (R_{p0.2}) may be set to 1010, 1020, 1030, 1040, 1050 or 1460 MPa.

The lower limit for the total elongation (A₈₀) may be set to 6 or 7%.

The lower limit for the hole expansion ratio (λ) may be set to 45, 50, 55 or 60%.

The lower limit for the yield ratio (R_{p0.2}/Rₘ) should be at least 0.60 and may be set to 0.64, 0.66, 0.68, 0.70 or 0.72.

The Rₘ, R_{p0.2} and A₈₀ values are derived according to the European norm EN 10002 Part 1, wherein the samples were taken in the longitudinal direction of the strip.

The hole expanding ratio (λ) is determined by the hole expanding test according to ISO/WD 16630:2009 (E). In this test a conical punch having an apex of 60° is forced into a 10 mm diameter punched hole made in a steel sheet having the size of 100×100 mm². The test is stopped as soon as the first crack is determined and the hole diameter is measured in two directions orthogonal to each other. The arithmetic mean value is used for the calculation.

The hole expanding ratio (λ) in % is calculated as follows:

λ=(Dh−Do)/Do×100

wherein Do is the diameter of the hole at the beginning (10 mm) and Dh is the diameter of the hole after the test.

The product of the tensile strength and the hole expansion ratio Rₘ×λ was calculated to evaluate the balance between the strength and the workability formability i.e. the stretch-flangability.

The product of the tensile strength and the hole expansion ratio Rₘ×λ of the cold rolled steel of the present invention should preferably be at least 60000 MPa %. The lower limit of this product can be set to 65000, 70000, 75000, 80000 or 85000 MPa %.

The bendability was evaluated by the ratio of the limiting bending radius (Ri), which is defined as the minimum bending radius with no occurrence of cracks, and the sheet thickness, (t). For this purpose, a 90° V-shaped block is used to bend the steel sheet in accordance with JIS Z2248. The samples were examined both by eye and under optical microscope with 25 times magnification in order to investigate the occurrence of cracks. The value obtained by dividing the limit bending radius with the thickness (Ri/t) should be less than 5. Preferably, the value (Ri/t) should be ≤4, ≤3 or ≤2.

The yield strength of the cold rolled steel of the present invention can be increased by subjecting the steel to Bake Hardening (BH). The increase in yield strength after 2% stretching in a tensile test BH₂ may be at least 30 MPa, wherein the BH₂-value is determined in accordance with DIN EN10325. The lower limit may be set to 35, 40 or 45 MPa.

The mechanical properties of the steel strips and sheets of the present invention can be largely adjusted by the alloying composition and the microstructure. Conventional steelmaking using continuous casting and hot rolling is used to produce a hot rolled strip. The hot rolled strip is pickled and thereafter batch annealed at about 580° C. for a total time of 10 hours in order to reduce the tensile strength of the hot rolled strip and thereby reducing the cold rolling forces before cold rolling to a final thickness. The cold rolled strips may thereafter be subjected to continuous annealing in a Continuous Annealing Line (CAL).

The microstructure may be adjusted by the heat treatment in the CAL, in particular by the isothermal treatment temperature in the overaging step. Usually, such isothermal treatment temperature in the overaging step is a bit below Mₛ temperature (such as 50° C. to 100° C. below Ms) but it is possible to heat treat in the overaging step at Ms temperature or up to 100° C. above Ms.

As an alternative, it is possible to use the Quench and Partitioning (Q&P) process to adjust the mechanical properties of the steel sheet. The material is then annealed and thereafter cooled to a temperature below the Mₛ temperature, reheated to a partitioning temperature above the Mₛ temperature, held at this temperature for partitioning and finally cooled to room temperature. Optionally, the material subjected to Q&P may also be subjected to a batch annealing step at a low temperature (about 200° C.) in order to fine tune the mechanical properties, in particular the yield strength and the hole expansion ratio.

The material produced via isothermal route in the CAL may also be subjected to a batch annealing step at a low temperature (about 200° C.) in order to fine tune the mechanical properties, in particular the yield strength and the hole expansion ratio.

The invention defines a cold rolled steel strip or sheet having:

a) a composition consisting of (in wt. %):

| | |
|---|---|
| C | 0.15-0.25 |
| Si | 0.5-1.6 |
| Mn | 2.2-3.2 |
| Cr | ≤0.8 |
| Mo | ≤0.2 |
| Al | 0.03-1.0 |
| Nb | ≤0.04 |
| V | ≤0.04 |
| Ti | 0.01-0.04 |
| B | 0.001-0.010 |
| Ti/B | 5-30 |
| Cu | ≤0.15 |
| Ni | ≤0.15 |
| Ca | ≤0.01 |

balance Fe apart from impurities,

b) a multiphase microstructure comprising (in vol. %):

| | |
|---|---|
| tempered martensite | ≥40 |
| bainitic ferrite | ≤40 |
| fresh martensite | ≤20 |
| retained austenite | 2-20 |
| polygonal ferrite | ≤10, |

c) the following mechanical properties

| | | |
|---|---|---|
| a tensile strength (Rₘ) | ≥1380 | MPa |
| yield strength (R_{p0.2}) | ≥1000 | MPa |
| total elongation (A₈₀) | ≥5 | % |
| hole expansion ratio (λ) | ≥40 | % |
| bendability (Ri/t) | ≤5. | |

The cold rolled steel strip or sheet of the present invention may have a composition comprising at least one of

| | |
|---|---|
| Cr | 0.1-0.8 |
| Si | 0.6-1.6 |
| B | 0.001-0.008 |

and optionally at least one of

| | |
|---|---|
| Cu | ≤0.10 |
| Ni | ≤0.10 |
| Nb | ≤0.005 |
| V | ≤0.01 |
| Ca | ≤0.005. |

The cold rolled steel strip or sheet may have an amount of retained austenite is at least 4 vol. % and the amount of polygonal ferrite is less than 6 vol. % and, optionally, the steel composition comprises at least one of

| | |
|---|---|
| Mn | 2.3-3.4 |
| Si | 0.7-1.5 |
| B | 0.001-0.006. |

The cold rolled steel strip or sheet may have a multiphase microstructure which fulfils the following requirements (in vol. %):

| | |
|---|---|
| tempered martensite | ≥50 |
| bainitic ferrite | ≤30 |
| fresh martensite | ≤15 |
| retained austenite | 5-15 |
| polygonal ferrite | ≤5, |

and wherein the cold rolled steel strip or sheet fulfils at least one of the following requirements

| | | |
|---|---|---|
| hole expansion ratio (λ) | ≥50 | % |
| Rₘ × λ | ≥60000 | MPa % |
| yield ratio (R_{p0.2}/Rₘ) | ≥0.60. | |

The cold rolled steel strip or sheet can become an increase in yield strength after 2% stretching in a tensile test, the BH₂-value, of at least 30 MPa.

The cold rolled steel strip or sheet may have a multiphase microstructure, which fulfils at least one of the following requirements (in vol. %):

| | |
|---|---|
| tempered martensite | ≥60 |
| bainitic ferrite | ≤20 |
| fresh martensite | ≤10 |
| retained austenite | 6-14 |
| polygonal ferrite | ≤3 |

and/or wherein the cold rolled steel strip or sheet fulfils at least one of the following requirements

| | | |
|---|---|---|
| hole expansion ratio (λ) | ≥55 | % |
| Rₘ × λ | ≥65000 | MPa % |
| yield ratio (R_{p0.2}/Rₘ) | ≥0.70. | |

The cold rolled steel strip or sheet according may have a composition, which fulfils at least one of the of the following requirements with respect to the impurity contents (in wt. %):

| | |
|---|---|
| P | ≤0.02 |
| S | ≤0.005 |
| N | 0.002-0.006. |

The cold rolled steel strip or sheet may have a composition fulfilling at least one of the following requirements with respect to the impurity contents (in wt. %):

| | |
|---|---|
| P | ≤0.01 |
| S | ≤0.003 |
| N | 0.003-0.005 |
| Sn | ≤0.015 |
| Zr | ≤0.006 |
| As | ≤0.012 |
| Ca | ≤0.005 |
| H | ≤0.0003 |
| O | ≤0.0020. |

The cold rolled steel strip or sheet may fulfil all requirements of claims 1, 2 and 3 and, optionally, the requirements of claim 4. The cold rolled steel strip or sheet may further be provided with a Zn containing layer.

### Example 1

A steel having the following composition was produced by conventional metallurgy by converter melting and secondary metallurgy:

| | |
|---|---|
| C | 0.20 |
| Si | 0.85 |
| Mn | 2.5 |
| Cr | 0.34 |
| Al | 0.049 |
| Ti | 0.026 |
| B | 0.0035 |
| Cu | 0.01 |
| Ni | 0.01 |
| P | 0.01 |
| S | 0.0005 |
| N | 0.0035 |

balance Fe and impurities.

The steel was continuously cast and cut into slabs. The slabs were reheated and subjected to hot rolling to a thickness of about 2.8 mm. The hot rolling finishing temperature was about 900° C. and the coiling temperature about 550° C. The hot rolled strips were pickled and batch annealed at about 580° C. for a total time of 10 hours in order to reduce the tensile strength of the hot rolled strip and thereby reducing the cold rolling forces. The strips were thereafter cold rolled in a five stand cold rolling mill to a final thickness of about 1.35 mm and finally subjected to continuous annealing in a Continuous Annealing Line (CAL).

The annealing cycle consisted of heating to a temperature of about 850° C., soaking for about 120 s, cooling during 30 seconds to an overaging temperature of about 250° C., thereafter isothermal holding at the overaging temperature for about 3 minutes and finally cooling to the ambient temperature. The strip thus obtained had a matrix of TM and contained 9% BF, 8% FM and 11% RA. The strip had a tensile strength (Rₘ) of 1450 MPa and a yield strength (R_{p0.2}) of 1080 MPa resulting in a yield ratio of 0.75. The total elongation (A₈₀) was 7% and the hole expansion ratio (λ) was 59%. Accordingly, the product R_{m×λ} was 85500 MPa %.

The Rₘ and R_{p0.2} values are derived according to the European norm EN 10002 Part 1, wherein the samples were taken in the longitudinal direction of the strip. The elongation (A₈₀) is derived in accordance with the same norm.

The hole expanding ratio (λ) is the mean value of three samples subjected to hole expansion tests (HET) according to ISO/TS16630:2009 (E).

### Example 2

A steel having the following composition was produced by conventional metallurgy by converter melting and secondary metallurgy:

| | |
|---|---|
| C | 0.21 |
| Si | 1.11 |
| Mn | 2.6 |
| Cr | 0.14 |
| Al | 0.052 |
| Ti | 0.024 |
| B | 0.0031 |
| Cu | 0.01 |
| Ni | 0.01 |
| P | 0.01 |
| Si | 0.0005 |
| N | 0.0035 |

balance Fe and impurities.

The steel was continuously cast and cut into slabs. The slabs were reheated and subjected to hot rolling to a thickness of about 2.8 mm. The hot rolling finishing temperature was about 900° C. and the coiling temperature about 550° C. The hot rolled strips were pickled and batch annealed at about 580° C. for a total time of 10 hours in order to reduce the tensile strength of the hot rolled strip and thereby reducing the cold rolling forces. The strips were thereafter cold rolled in a five stand cold rolling mill to a final thickness of about 1.35 mm and finally subjected to continuous annealing in a Continuous Annealing Line (CAL).

The annealing cycle consisted of heating to a temperature of about 840° C., soaking for about 120 s, cooling during 30 seconds to an overaging temperature of about 260° C., thereafter isothermal holding at the overaging temperature for about 3 minutes and finally cooling to the ambient temperature. The strip thus obtained had a matrix of TM and contained 12% BF, 10% FM and 12% RA. The strip had a tensile strength (Rₘ) of 1470 MPa and a yield strength (R_{p0.2}) of 1030 MPa resulting in a yield ratio of 0.70. The total elongation (A₈₀) was 8% and the hole expansion ratio (λ) was 61%. Accordingly, the product R_{m×λ}, was 89670 MPa %.

The mechanical properties were derived in the same way as in example 1.

The material of the present invention can be widely applied to high strength structural parts in automobiles. The high ductility high strength cold rolled steel strips and sheets of the present invention are particularly well suited for the production of parts having high demands on the local elongation.

1. A cold rolled steel strip or sheet having:
a) a composition consisting of (in wt. %):

| | |
|---|---|
| C | 0.15-0.25 |
| Si | 0.5-1.6 |
| Mn | 2.2-3.2 |
| Cr | ≤0.8 |
| Mo | ≤0.2 |
| Al | 0.03-1.0 |
| Nb | ≤0.04 |
| V | ≤0.04 |
| Ti | 0.01-0.04 |
| B | 0.001-0.010 |
| Ti/B | 5-30 |
| Cu | ≤0.15 |
| Ni | ≤0.15 |
| Ca | ≤0.01 |

balance Fe apart from impurities,
b) a multiphase microstructure comprising (in vol. %):

| | |
|---|---|
| tempered martensite | ≥40 |
| bainitic ferrite | ≤40 |
| fresh martensite | ≤20 |
| retained austenite | 2-20 |
| polygonal ferrite | ≤10, |

and
c) the following mechanical properties

| | | |
|---|---|---|
| a tensile strength (Rₘ) | ≥1380 | MPa |
| yield strength (R_{p0.2}) | ≥1000 | MPa |
| total elongation (A₈₀) | ≥5 | % |
| hole expansion ratio (λ) | ≥40 | % |
| | |
|---|---|
| bendability (Ri/t) | ≤5. |

2. A cold rolled steel strip or sheet according to claim 1, wherein the steel composition comprises:
at least one of

| | |
|---|---|
| Cr | 0.1-0.8 |
| Si | 0.6-1.6 |
| B | 0.001-0.008 |

and optionally at least one of

| | |
|---|---|
| Cu | ≤0.10 |
| Ni | ≤0.10 |
| Nb | ≤0.005 |
| V | ≤0.01 |
| Ca | ≤0.005. |

3. A cold rolled steel strip or sheet according to claim 1, wherein the amount of retained austenite is at least 4 vol. % and the amount of polygonal ferrite is less than 6 vol. % and, optionally, the steel composition comprises at least one of:

| | |
|---|---|
| Mn | 2.3-3.4 |
| Si | 0.7-1.5 |
| B | 0.001-0.006. |

4. A cold rolled steel strip or sheet according to claim 1, wherein the multiphase microstructure fulfils the following requirements (in vol. %):

| | |
|---|---|
| tempered martensite | ≥50 |
| bainitic ferrite | ≤30 |
| fresh martensite | ≤15 |
| retained austenite | 5-15 |
| polygonal ferrite | ≤5, |

and wherein the cold rolled steel strip or sheet fulfils at least one of the following requirements

| | | |
|---|---|---|
| hole expansion ratio (λ) | ≥50 | % |
| Rₘxλ | ≥60000 | MPa % |
| | |
|---|---|
| yield ratio (Rp_{0.2}/Rₘ) | ≥0.60. |

5. A cold rolled steel strip or sheet according to claim 1, wherein the increase in yield strength after 2% stretching in a tensile test, the BH₂-value, is least 30 MPa.

6. A cold rolled steel strip or sheet according to claim 1, wherein the multiphase microstructure fulfils at least one of the following requirements (in vol. %):

| | |
|---|---|
| tempered martensite | ≥60 |
| bainitic ferrite | ≤20 |
| fresh martensite | ≤10 |
| retained austenite | 6-14 |
| polygonal ferrite | ≤3, |

and/or wherein the cold rolled steel strip or sheet fulfils at least one of the following requirements

| | | |
|---|---|---|
| hole expansion ratio (λ) | ≥55 | % |
| Rₘxλ | ≥65000 | MPa % |
| | |
|---|---|
| yield ratio (Rp_{0.2}/Rₘ) | ≥0.70. |

7. A cold rolled steel strip or sheet according to claim 1, wherein the steel composition fulfils at least one of the of the following requirements with respect to the impurity contents (in wt. %):

| | |
|---|---|
| P | ≤0.02 |
| S | ≤0.005 |
| N | 0.002-0.006. |

8. A cold rolled steel strip or sheet according to claim 1, having:
a) a composition fulfilling at least one of the following requirements with respect to the impurity contents (in wt. %):

| | |
|---|---|
| P | ≤0.01 |
| S | ≤0.003 |
| N | 0.003-0.005 |
| Sn | ≤0.015 |
| Zr | ≤0.006 |
| As | ≤0.012 |
| Ca | ≤0.005 |
| H | ≤0.0003 |
| O | ≤0.0020. |

9. A cold rolled steel strip or sheet fulfilling all requirements of claim 1.

10. A cold rolled steel strip or sheet according to claim 1, wherein the cold rolled steel is provided with a Zn containing layer.
